(19) United States
(12) Patent Application Publication
(10) Pub. No.: US 2017/0135053 A1
(43) Pub. Date: May 11, 2017

(54) Localized Timing Distribution Using Radio Signals

(71) Applicant: QULSAR, INC., San Jose, CA (US)

(72) Inventors: Kishan Shenoi, Saratoga, CA (US); Lincolm Worsham, San Jose, CA (US); Nishanth Satyanarayana, San Jose, CA (US)

(73) Assignee: QULSAR, INC., San Jose, CA (US)

(21) Appl. No.: 15/249,932

(22) Filed: Aug. 29, 2016

Related U.S. Application Data
(60) Provisional application No. 62/199,048, filed on Jul. 30, 2015.

(51) Int. Cl. H04W 56/00; H04L 29/06

(52) U.S. Cl. CPC H04W 56/001; H04L 67/42; H04W 84/20

(57) ABSTRACT

A master and slave module are described that facilitate the distribution of timing, both frequency and phase over a radio link The signal transmitted from the master to the slave is suitable for delivering a frequency reference and an approximate phase/time. The precise phase at the slave is obtained by using a reverse communication between the slave and the master over the same radio channel in a time-division-duplex mode. Additional slaves can be accommodated by using a multiple time-slot arrangement.

### CROSS-REFERENCE TO RELATED APPLICATION

Referring to the application data sheet filed herewith, this application claims a benefit of priority under 35 U.S.C. 119(e) from co-pending provisional patent application U.S. Ser. No. 62/199,048, filed Jul. 30, 2015, the entire contents of which are hereby expressly incorporated herein by reference for all purposes.

### BACKGROUND

Field

Embodiments of this disclosure relate generally to phase and frequency alignment systems pertaining to the distribution of timing from one unit (master) to a second unit (slave) using radio signals.

Description of the Problem

There are numerous areas where the need for distributing timing, both frequency and phase, in a wireless fashion is manifested. One such area is described here by way of example.

Packet-based timing methods are becoming essential for delivering timing over packet-switched networks, often referred to as the cloud. In particular, Precision Timing Protocol (PTP) (aka IEEE 1588-2008) is becoming a defacto standard for delivering timing information (time/phase/frequency) from a Grand Master (GM) clock to slave clocks in end application-specific equipment; for example, where wireless base stations providing mobile telephony services require precise timing and the backhaul method of choice is Ethernet. The Grand Master clock provides timing information over the packet-switched network to the slave clocks by exchanging packets with embedded time-stamps related to the time-of-arrival and time-of-departure of the timing packets. The slave clock utilizes this information to align its time (and frequency) with the Grand master. The Grand Master is provided an external reference to serve as the basis for time and frequency. Most commonly this reference is derived from a Global Navigation Satellite System (GNSS) such as the GPS System that in turn is controlled by the US Department of Defense and its timing controlled very precisely and linked to the US Naval Observatory. Time alignment to the GPS clock is, for all practical purposes equivalent to time alignment to UTC.

The packet network between the network elements containing the master and slave clocks introduces timing impairments in the form of packet delay variation in each direction of transmission and, further, asymmetry in the transmission paths of the two directions both in terms of basic latency and delay variation. There are situations where the packet delay variation in the network, which could be wired (e.g. Ethernet) or even wireless (e.g. WiFi) could be excessive, severely degrading the ability of the slave clock to recover timing from the GM over the network. This situation is especially true in cases such as wireless base-stations that are targeted for small coverage areas and hence often referred to as “small cells”. Such devices are intended to be of very low cost and hence it is not cost-effective to include an expensive oscillator. It is well known that the ability to tolerate packet delay variation in the network is closely related to the performance, and hence cost, of the oscillator.

One approach that is well known is the inclusion of a GNSS (e.g. GPS) receiver function in the small cell. The GNSS receiver will utilize the available radio frequency signals from the GNSS satellites and from that develop a solution for its position (e.g. latitude/longitude/height) as well as time. From this solution the receiver can generate a timing signal, typically a pulse train with a rate of 1 pulse-per-second (1PPS), together with a messaging channel carrying a data stream comprising the time-of-day at the defining pulse-edge (signal transition) of the 1PPS signal. This combination of event signal and messaging channel is referred to as 1PPS+ToD. The backhaul channel whereby the small cell connects with the network can still be used to carry packet-based timing signals (e.g. PTP) and this can be used as a back-up to generate timing for the small cell when the GNSS signal is interrupted for any reason. This method of operation is referred to as “assisted timing support” (see for example, Ref. [1]).

There are cases where the small cell is deployed indoors and a built-in GNSS antenna may not have adequate signal strength or quality to develop a good timing solution. One possible approach to this problem is to deploy a GNSS antenna in a location, such as “in the window” and use cable, typically coax cable, to connect to the small cell itself. This has some obvious drawbacks such as the length of cable required and the portability of the small cell development.

In addition to this stated example of providing timing to wireless base-stations, embodiments of this disclosure can be used to provide timing from a Timing Server to other devices that need time such as devices in the Internet-of-Things. It should be further noted that variations of the synchronization arrangement include two-way (for precise time), one-way (for approximate time), and different forms of radio links including channels in the ISM band, Bluetooth, and other short-range and medium-range radio technologies.

### SUMMARY

The solution proposed here is to incorporate the GNSS receiver in a small device, referred to here as the Timing Server, that is located where GNSS signal coverage is adequate. The Timing Server includes a module called the Wireless Master (WM) that accepts the timing from the GNSS receiver and then transfers timing between the said device (WM) and a module, the Wireless Slave (WS), incorporated in the small cell, using radio signals. The small cell will include a receiver purpose-built for this application, referred to as Wireless Slave (WS), that will synchronize with the WM and deliver the requisite timing signals, for example 1PPS+ToD, to the small cell circuitry. This is depicted in simplified form in FIG. 1.

As depicted in FIG. 1, the Timing Server 100 includes a GNSS receiver 120 that is connected to a GNSS antenna 110 that has reasonable GNSS signal reception. The GNSS receiver provides a timing signal 130, typically a (1PPS+ToD), to the Wireless Master (WM) unit 140. The Timing Client 180 includes a Wireless Slave (WS) 160. The Timing Client 180 could be, for example, a small cell as in the example considered. The remaining circuitry in 180 that defines the actual functionality (e.g. wireless base-station) is not shown since those consumer functionalities are readily commercially available but requires a timing signal and this timing signal is provided by the WS 160 in the form of, for example, a (1PPS+ToD) 170. The WS 160 is synchronized to the WM 140 and consequently the (1PPS+ToD) 170 can be viewed as a transferred version of the (1PPS+ToD) 130 originating from the GNSS receiver.

The synchronization over the Radio Link 150 is described in detail later. The principle is to send a burst of information with a particular recognizable pattern that defines an “event” and the time value of the sender's clock at the instant the event is transmitted.

It should be noted that the GNSS receiver 120 can be substituted by other modules that can provide the time reference (1PPS+ToD) 130. It should be further noted that variations of the synchronization 150 include two-way (for precise time), one-way (for approximate time), and different forms of radio links including channels in the ISM band, Bluetooth, and other short-range and medium-range radio technologies.

### BRIEF DESCRIPTION OF THE DRAWINGS

FIG. 1 illustrates a block diagram representing transfer of timing

FIG. 2 illustrates a block diagram representing a timing signal.

FIG. 3 illustrates a schematic diagram representing a burst transmission.

FIG. 4 illustrates a schematic diagram representing a burst transmission.

FIG. 5 illustrates a block diagram representing a repetition.

FIG. 6 illustrates a block diagram representing a phase locked loop.

FIG. 7 illustrates a schematic diagram representing generating a periodic signal.

FIG. 8 illustrates a timing diagram.

FIG. 9 illustrates a schematic diagram representing using time-slots.

FIG. 10 illustrates a schematic diagram representing using time-slots.

### DETAILED DESCRIPTION

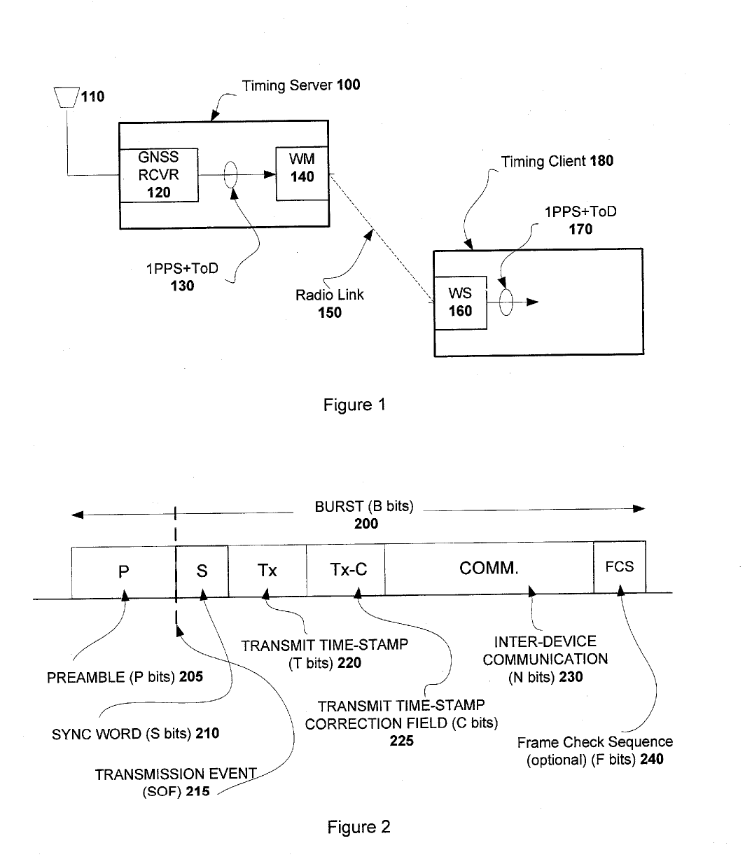

FIG. 1 is a conceptual diagram that depicts the transfer of timing between a Timing Server 100 and Timing Client 180; the Timing Server includes the Wireless Master 140 and the Timing Client includes the Wireless Slave 160; the synchronization is over a radio link 150.

FIG. 2 depicts the structure of the timing signal; one burst of the transmission is depicted; the transmission order is from left to right in the figure.

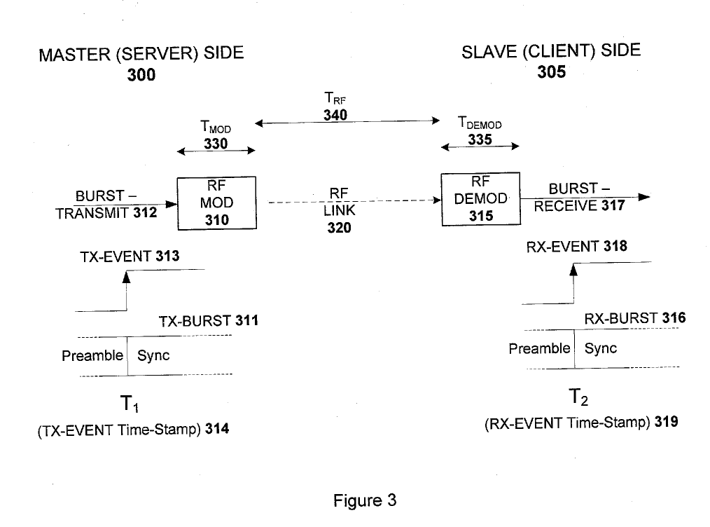

FIG. 3 provides a high level view of the burst transmission between the Sender and Receiver and time-delay incurred in transmission between the sender transmitter and receiver; the sender is assumed to be the Master (Server) side and the receiver is assumed to be the Slave (Client) side.

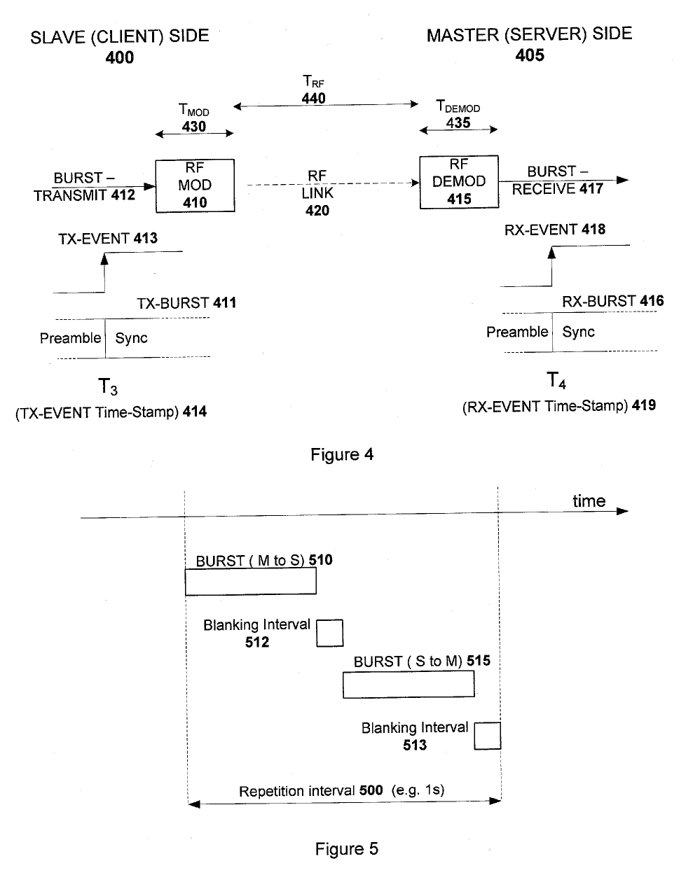

FIG. 4 provides a high level view of the burst transmission between the Sender and Receiver and time-delay incurred in transmission between the sender transmitter and receiver; the sender is assumed to be the Slave (Client) side and the receiver is assumed to be the Master (Server) side.

FIG. 5 illustrates the relationship of the burst transmissions in the two directions in the case where there is a Master and a single slave and the burst repetition rate is one burst (each direction) per second; to ensure non-overlapping, there is a blanking interval (silent interval) between bursts.

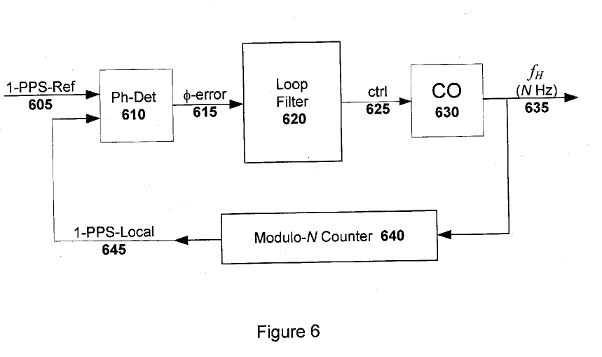

FIG. 6 provides a schematic view depicting the phase-locked loop for generating a local replica of a 1-PPS signal that is locked to the reference 1-PPS signal.

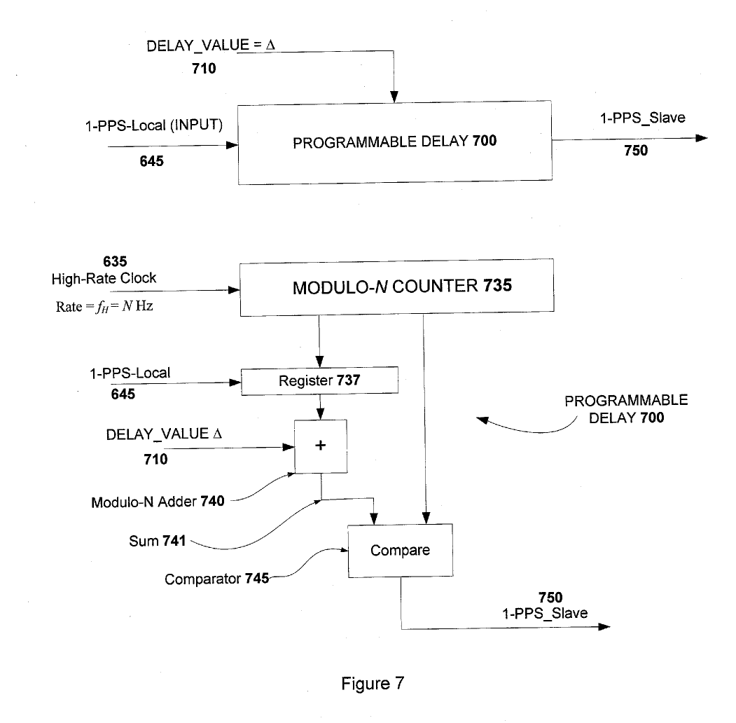

FIG. 7 illustrates the approach for generating a delayed/advanced version of a periodic signal such as a 1-PPS (one-pulse-per-second) with programmable delay/advance value.

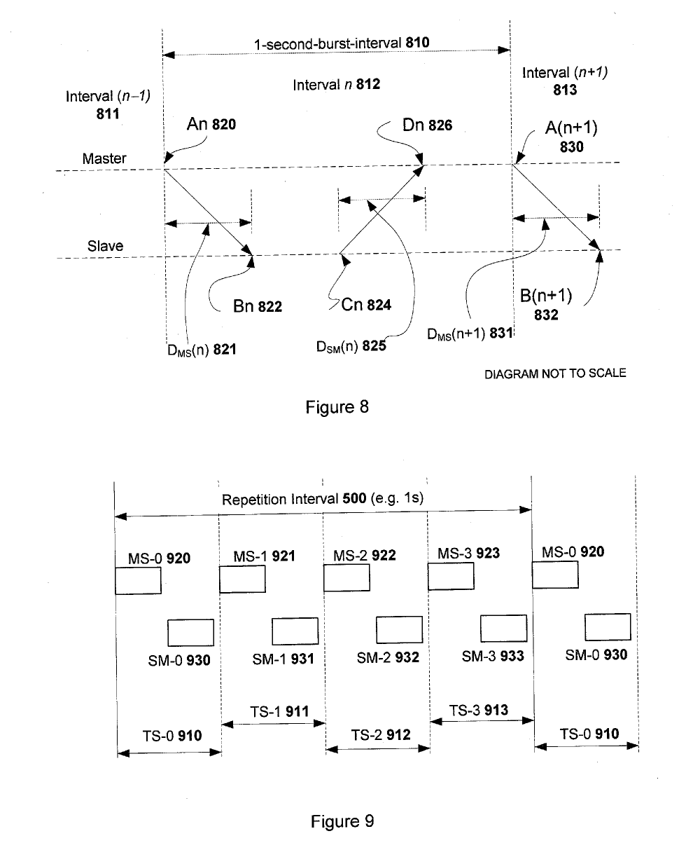

FIG. 8 illustrates the timing diagram inherent in the transmission of a burst event as it flows from the master module to the slave and the slave sends a burst back to the master module.

FIG. 9 depicts the approach of using time-slots to communicate between a single master and numerous slaves.

FIG. 1 is a simplified block diagram representing an area of application of embodiments of this disclosure. Different embodiments of this disclosure are suitable for delivering a timing reference from one card, card-A, the “master”, containing a master module, over the backplane to several cards such as card-B, containing a slave module, the action referred to as intra-network-element timing transfer.

The Wireless Master (WM) 140 module accepts timing reference (1PPS+ToD) 130 and provides a timing reference to the paired Wireless Slave (WS) 160 modules in other devices (e.g. Timing Client 180). The WS module, e.g. 160, provides a timing reference (1PPS+ToD) 170 to the other circuitry in the Timing Client 180. Whereas FIG. 1 depicts a single timing client, the method can be extended whereby each Timing Server can support multiple Timing Clients.

The manner in which timing is transferred is by transmission of a burst of information. The principal characteristics of the information burst are depicted in FIG. 2. The information burst 200 is composed of B bits as shown in the figure. The start of the burst is the preamble pattern 205 that has at least P bits. Whereas there are several choices of bit patterns for the preamble, it is recommended that the pattern be simple and not easily confused with other data. In practice preambles are usually an “all ones” pattern which is easy to detect. Another advantage of an “all-ones” pattern is that when encoded for transmission as return-to-zero pulses the pattern provides a signal that is very conducive for clock recovery because it has many edges. Other coding schemes such as Manchester encoding can be used which have the property of providing edges facilitating clock recovery for all patterns including “all ones” and “all zeros” as well.

Following the preamble is the “sync word” 210 composed of S bits. The sync word pattern is very important because the demarcation between the preamble and the sync word defines an event 215 that is referred to here as a “start-of-frame” or SOF. A typical value for S is 16 (bits). The transmit time-stamp 220 provides the time of the sender's clock corresponding to the instant that the start-of-frame is sent. The time value in 220 is encoded in T bits. A typical value of T is 64 (bits). In some cases it is advantageous to associate an additional, optional, time-stamp-related field with the transmit time stamp that is shown in FIG. 2 as the transmit time-stamp correction field 225 composed of C bits. Following the time-stamp fields is a collection of fields generally referred to in FIG. 2 as inter-device communication 230 to permit delivery of general purpose information from sender to receiver. The N bits allocated to the inter-device communication can carry a wide variety of messages.

One example of message is the value of the sender's clock at the instant that the last transmission burst was received at the sender from the distant side. That is, the N-bit field 230 contains a subfield of T bits (typically T is 64). Other examples are messages related to network and device management and supervision or other general purpose communication.

For robust operation it is advantageous to include a frame check sequence. The frame check sequence 240 composed of F bits can be computed as a cyclic redundancy code (CRC) check over the rest of the data in the burst including the sync word 210, the transmit time-stamp 220 and time-stamp correction 225, and the general communication field 230. A typical value for F is 16 (bits).

The complete transmission burst size B is thus B=(P+S+T+C+N+F) (bits). Whereas it is advantageous to fix the field sizes of the important fields (S+T+C+N+F), the size of the preamble is somewhat flexible and it suffices that P be sufficiently large that the receiver can achieve proper symbol timing to facilitate the extraction of the information bits in the burst.

For example, if the time-stamp field 220 is 64 bits (T=64) and if the correction field is not utilized and the N-bit field 230 includes T=64 bits for the received time-stamp and 32 bits for general communication, and the sync 210 and frame check sequence 240 fields are each 16 bits, with a 64-bit preamble (P=64 bits) the overall burst size is 256 bits.

The bit rate employed is constrained by the size of the burst (B bits) and the available time for the burst. The available time for the burst in turn depends on the chosen repetition rate, the number of Slaves, and the choice of blanking time which is the silent interval between bursts from either side.

FIG. 3 illustrates the timing events associated with a transmission burst from the Master (Server) Side 300 to the Slave (Client) Side 305. The Master develops the content of the burst 312 and provides the signal to the RF modulator (RF Mod) 310. The function of the modulator is to translate the digital waveform into an RF signal at the desired carrier frequency using modulation techniques. In this particular case it is advantageous to use a simple binary modulation method such a phase-shift-keying (PSK) or frequency-shift-keying (FSK) and there are several similar methods. The timing event (“TX-EVENT”) 313 is the edge associated with the boundary between the Preamble and the Sync patterns in the transmission burst 311. T₁ is the TX-EVENT time-stamp 314 that is the value of the master side clock at the instant of the TX-EVENT which is the instant corresponding to the boundary between the preamble and sync patterns as fed to the RF Mod 310. This time-stamp is included in the burst in the time-stamp field 220.

In the case where the transmission repetition rate is once per second, it is advantageous to align the TX-EVENT 313 with the “seconds” rollover of the clock. That is, the TX-EVENT 313 is aligned with the start of a new one-second interval (end of the old one-second interval) where the time counter corresponds to an integer number of seconds (the fractional seconds part of the time counter is zero).

The function of the demodulator is to extract the digital waveform from the incoming RF signal at the known carrier frequency using demodulation techniques. The timing event (“RX-EVENT”) 318 is the edge associated with the boundary between the Preamble and the Sync patterns in the received transmission burst 316. T₂ is the RX-EVENT time-stamp 319 that is the value of the slave side clock at the instant of the RX-EVENT which is the instant corresponding to the boundary between the preamble and sync patterns as received from the RF Demod 315.

The RF Mod 310 function introduces a delay T_{MOD} 330 that is a constant and can be measured and accounted for. The actual transmission delay in the RF link 320 is given by T_{RF} 340 and is dependent on the physical distance between the master side unit and the slave side unit and is not known a priori but, as will be seen later, can be estimated during actual operation. The RD Demod 315 extracts the burst signal waveform from the incoming RF signal by suitable demodulation methods and produces a copy, RX-BURST 316, of the sent transmission burst TX-BURST 311. The RF Demod 315 function introduces a delay T_{DEMOD} 335 that is a constant and can be measured and accounted for.

Referring to FIG. 4, transmission from client to server is illustrated. When operated in a two-way manner, the Slave (Client) side device transmits bursts that are received by the Master (Server) side. The operation is analogous to the situation when the Master side transmits the burst. Of special significance are the time stamps T₃ 414 and T₄ 419 corresponding to the time value of the TX-EVENT 413 according to the local (slave-side) clock and the time value of the RX-EVENT 418 according to the local (master side) clock.

Note that T₁ 314 and T₃ 414 are transmit time-stamps, according to the local clock, of the transmit burst event from the master side and from the slave side, respectively. These are included in the transmit time-stamp field 220 of the burst transmission. Note that T₂ 319 and T₄ 419 are receive time-stamps, according to the local clock, of the received burst event at the slave side and at the master side, respectively. These time-stamps are communicated to the other side at the very next burst opportunity and included as a component of the inter-device communication 230.

Whereas the burst repetition rate can be a value that is agreed upon by the two sides, it is convenient to consider the case where the repetition rate is once per second. This choice of repetition rate simplifies the circuitry required for adaptation because most time reference signals are composed of a (1PPS+ToD) set where there is a signal that provides an edge (event marker) every second and a separate message channel where the message provides the time value at the event (or at the next event). Furthermore, it is advantageous to allow for a two-way burst communication to complete within the 1 second interval. Considering that some time may elapse for transmission over the RF channel and that the devices may require some time to turn around and switch from transmit (receive) mode to receive (transmit) mode, an adequate interval should be provided between the end of a burst in one direction and start of burst in the other direction. This is illustrated in FIG. 5. As shown in FIG. 5, the repetition interval 500 is shown for exemplary purposes as 1 s. At the start of the 1-second interval the Master side issues a transmission burst 510 followed by a blanking interval of silence 512 up to half-way through the repetition interval (0.5 s). At the halfway mark the Slave side issues a burst transmission 515 followed by a blanking interval 513. The Slave is silent in the first half-second and the Master is silent in the second half-second.

The local oscillator in the slave can be locked to the reference 1-PPS signal as depicted in FIG. 6. The reference 1-PPS input 605 (1-PPS-Ref) is derived from the RX-EVENT 318 (see FIG. 3). In particular, assuming a burst repetition interval of 1 s, the signal RX-EVENT 318 can be used as the 1-PPS-Ref 605 signal. Whereas one implementation of a phase-locked-loop is depicted in FIG. 6, embodiments of this disclosure are not limited to this implementation. As shown in FIG. 6, a phase-detector Ph-Det 610 establishes the phase error φ-error 615 between the 1-PPS-ref 605 and a locally generated 1-PPS signal, 1-PPS-Local 645. The loop filter 620 smooths out the phase error to generate the control signal ctrl 625 that is used to control (i.e. adjust) the frequency of the local oscillator CO 630. The local oscillator is a controlled oscillator and could be a voltage-controlled crystal oscillator (VCXO) or a digitally-controlled crystal oscillator (DCXO). The CO 630 generates a frequency output 635 with a rate of f_{H}=N Hz where N is a suitable value for the implementation (typically 10 MHz or 20 MHz). A Modulo-N counter 640 is used to divide down the frequency to 1 Hz and thereby generating the 1-PPS-Local 645 signal that is fed back to the phase detector 610. When the phase-locked-loop (PLL) is locked, the signals 1-PPS-Ref 605 and 1-PPS-Local 645 will be phase aligned.

The time value at the instant of the rising edge (chosen event) of 1-PPS-Local 645 is established as the time value of the corresponding rising edge of RX-EVENT 318. This is established by examining the transmit time-stamp 220 in the incoming burst. This represents the time value at the Master when the TX-EVENT 313 entered the RF Mod 310. The time value of RX-EVENT 318 according to the Master's clock will be this time-stamp (220) value plus the transmission delay as shown in FIG. 3 as the total of T_{MOD} 330 plus T_{DEMOD} 335 plus T_{RF} 340. Of these the modulation and demodulation delays, 330 and 335, can be calibrated and are, therefore, known a priori. The RF Link 320 introduces the delay T_{RF} 340 and is the remaining item that needs to be estimated in order to complete the estimate of the time value of RX-EVENT 318 according to the Master's clock.

As one possible scenario for deployment, the Master Side and Slave Side devices may not be separated by a great distance. For example, if the distance between the two sides is known a priori to be less than 300 m, then since the RF propagation is very close to the speed of light, the delay T_{RF} 340 is less than 1 microsecond. Assuming that the delay is 0.5 microsecond will introduce a time error of synchronization of less than 0.5 microsecond. If that level of error is acceptable to the application, then it is not mandatory to measure T_{RF}.

It is often advantageous to shift the 1-PPS-Local 645 so as to establish a 1-PPS signal that is in alignment with the Master clock 1-PPS. Specifically, it is advantageous to generate a 1-PPS signal called 1-PPS-Slave 750 (see FIG. 7) that corresponds to an advance in time of 1-PPS-Local 645 by an amount (T_{MOD} 330 plus T_{DEMOD} 335 plus T_{RF} 340) which is equivalent to a delay in time by an amount Δ=−(T_{MOD} 330 plus T_{DEMOD} 335 plus T_{RF} 340). This shift can be achieved by the arrangement depicted in FIG. 7. Note that an advance in time is equivalent to a delay by a negative time interval value.

As shown in FIG. 7, the programmable delay element 700 takes the 1-PPS-Local 645 signal as input and delays it by Δ 710 to produce the output 1-PPS-Slave 750. The arrangement uses a modulo-N counter 735 that is clocked by the local clock 635 that has a rate of N Hz. That is, the modulo-N counter 735 cycles through the numbers 0,1, . . . , (N−1) every second. The value of the counter is captured at the rising edge of the input 1-PPS signal, 1-PPS-Local 645 in Register 737. The delay value (typically a negative number is added to the content of Register 737 using Modulo-N arithmetic to create the Sum 741. A comparator 745 is used to detect when the modulo-N counter value is equal to the Sum 741. The detection event generates the rising edge for the 1-PPS-Slave 750 and this will be the appropriately delayed (advanced) version of 1-PPS-Local 645.

Note that the granularity of delay increments is equal to one cycle of the high-speed clock 635. Consequently it is advantageous for N to be a (very) large number. For example, if N=100,000,000 (=10⁸), the granularity of correction will be 0.01 microseconds or 10 ns; the clock rate will be f_{H}=100 MHz.

In order to improve the precision and accuracy of the synchronization between the Master Clock and Slave Clock, it is necessary to estimate the one-way delay that is composed of D_{MS}=(T_{MOD} 330 plus T_{DEMOD} 335 plus T_{RF} 340) (see FIG. 3) that represents the transmission delay of the burst in the master-to-slave direction. Similarly, D_{SM}=(T_{MOD} 430 plus T_{DEMOD} 435 plus T_{RF} 440) (see FIG. 4) represents the transmission delay of the burst in the slave-to-master direction. Since the modulation and demodulation delays are those associated with equivalent equipment (different copies of the same design), and since the transmission of radio waves in the same medium will be at the same velocity in either direction, it is proper to assume that the transmission delays D_{SM} and D_{MS} are equal, that is, the transmission is symmetric from a delay perspective.

The delay estimate is achieved using a two-way time-transfer method that involves burst transmission in both directions as depicted in FIG. 5. FIG. 8 depicts the actions in a two-way arrangement and identifies the key information transfer that takes place in each second interval that is used to estimate the delay D_{MS} (assumed to be equal to D_{SM}).

With reference to FIG. 8, there is a continual transmission of bursts between master and slave and between slave and master. There is one burst in each direction in each 1-second interval 810. For convenience each 1-second interval is indexed and the nth 1-second interval is shown with an index n 812. The prior 1-second interval has index (n−1) and the next 1-second interval index is (n+1). The master sends a burst towards the slave that has time-of-departure, i.e. TX-EVENT 313, and strikes the time-stamp, according to the local (Master) clock, which is usually referred to as “T₁” (TX-EVENT Time-stamp 314). This value can be called An 820 where the “n” identifies the 1-second interval index. This value is included in the burst (as transmit time-stamp 220). The burst from master to slave in 1-second interval index n also contains the value of D(n−1) which is the time-of-arrival of the burst from the slave to the master in 1-second interval index (n−1). The slave receives the burst and strikes the time-stamp, according to the local (Slave) clock, usually referred to as “T2” (RX-EVENT Time-stamp 319), of the time-of-arrival, i.e. RX-EVENT 318. This value can be called Bn 822 where the “n” identifies the 1-second interval index. The Slave sends a burst towards the slave that has time-of-departure, i.e. TX-EVENT 413, and strikes the time-stamp, according to the local (Slave) clock, which is usually referred to as “T₃” (TX-EVENT Time-stamp 414). This value can be called Cn 824 where the “n” identifies the 1-second interval index. This value is included in the burst (as transmit time-stamp 220). Also included in the burst as part of the inter-device communication, the Slave sends the value of Bn 822 of the time-of-arrival of the burst from master to slave. The Master receives the burst and strikes the time-stamp, according to the local (Master) clock, usually referred to as “T4” (RX-EVENT Time-stamp 419), of the time-of-arrival, i.e. RX-EVENT 418. This value can be called Dn 826 where the “n” identifies the 1-second interval index. This value Dn 826 is returned from Master to Slave in the next burst that occurs in 1-second interval indexed (n+1).

At the end of the 1-second interval n the Master has knowledge of (An, Bn, Cn, Dn); shortly thereafter, following the Master to Slave burst in 1-second interval (n+1), the Slave has knowledge of (An, Bn, Cn, Dn). Based on these values, both sides, and in particular the Slave side, can determine the time-offset between the Master and Slave clocks appropriate for the 1-second interval n with the assumption that the transmission path delay is symmetric in the two directions (i.e., assuming D_{MS}=D_{SM}). This is achieved using the formula provided below.

Denote by εₙ the time-offset between the Master and Slave clocks. Then:

$${ɛ}_{n} = \frac{( {B}_{n} - {A}_{n} ) + ( {C}_{n} - {D}_{n} )}{2} \qquad ( Eq . 1 )$$

This value is computed each second. In order to minimize the impact of measurement noise, it is advantageous to low-pass-filter this value and establish a long-term average that represents the (average) of the time-offset over several 1-second intervals. One simple calculation that achieves this low-pass-filter action is the recursion:

θₙ=γ·θ₍ₙ₋₁₎+(1−γ)·εₙ (Eq. 2)

where θₙ is the filtered version of εₙ. The parameter γ (with 0<γ<1) determines the bandwidth of the filter and a value closer to 1 represents a smaller bandwidth. Note that a smaller bandwidth indicates a longer settling time.

The programmable delay value chosen to generate the 1-PPS_Slave 750 is preferably the filtered value of time-offset.

In order to support multiple Slaves from 1 Master, there are two principal methodologies. The first approach is to address each slave separately and the Master module maintains a two-way communication separately with each slave. Assuming that each Slave is expecting a repetition interval of 1 s, FIG. 9 shows the exemplary case of 4 Slaves. The repetition interval is divided into 4 time-slots TS-0 910, TS-1 911, TS-2 912, and TS-3 913 with each time-slot dedicated for conversation between slave 0, slave 1, slave 2, and slave 3, respectively. In each time-slot will be a two-way exchange of bursts. For example, in time-slot TS-0 910 there will a burst from master to slave MS-0 920 and a burst from slave to master SM-0 930. Each slave will synchronize with the master using the methodology described before and each slave will be essentially independent of all other slaves. At start-up provisioning and configuration each Slave is allotted its own time-slot.

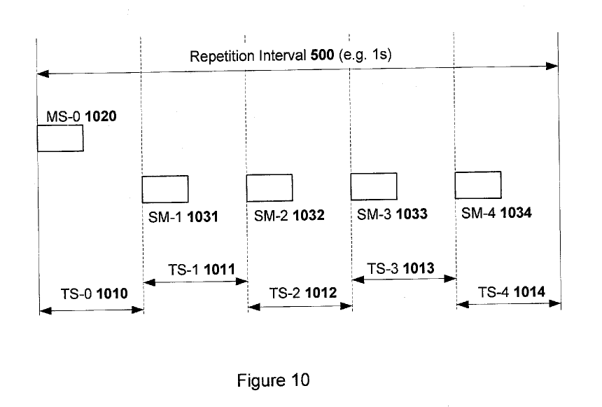

The second approach is multi-cast in nature. Here too each Slave is allocated its own time-slot. However, this time-slot applies for its reply burst to the Master. Thus if we have 4 slaves there will be 5 time-slots where time-slot 0 is dedicated to the Master burst that is broadcast to all slaves. Numbering the Slaves as 1, 2, . . . , time-slot 1 is reserved for the reply burst from Slave 1; time-slot 2 is reserved for the reply from Slave 2, and so on. FIG. 10 depicts the exemplary case of 4 Slaves. With reference to FIG. 10, the Master burst MS-0 1020 occurs in TS-0 1010. Note that the inter-device communication field in MS-0 1020 now has several subfields that are Slave specific to deliver the “T4” value of the prior 1-second interval. Slave 1 responds in TS-1 1011 with burst SM-1 1031.

A computer readable medium is intended to mean non-transitory computer or machine readable program elements translatable for implementing a method of this disclosure. The terms program and software and/or the phrases program elements, computer program and computer software are intended to mean a sequence of instructions designed for execution on a computer system (e.g., a program and/or computer program, may include a subroutine, a function, a procedure, an object method, an object implementation, an executable application, an applet, a servlet, a source code, an object code, a shared library/dynamic load library and/or other sequence of instructions designed for execution on a computer or computer system). The phrase radio frequency (RF) is intended to mean frequencies less than or equal to approximately 300 GHz as well as the infrared spectrum. The term light is intended to mean frequencies greater than or equal to approximately 300 GHz as well as the microwave spectrum.

The term uniformly is intended to mean unvarying or deviate very little from a given and/or expected value (e.g, within 10% of). The term substantially is intended to mean largely but not necessarily wholly that which is specified. The term approximately is intended to mean at least close to a given value (e.g., within 10% of). The term generally is intended to mean at least approaching a given state. The term coupled is intended to mean connected, although not necessarily directly, and not necessarily mechanically. The term deploying is intended to mean designing, building, shipping, installing and/or operating.

The terms first or one, and the phrases at least a first or at least one, are intended to mean the singular or the plural unless it is clear from the intrinsic text of this document that it is meant otherwise. The terms second or another, and the phrases at least a second or at least another, are intended to mean the singular or the plural unless it is clear from the intrinsic text of this document that it is meant otherwise. Unless expressly stated to the contrary in the intrinsic text of this document, the term or is intended to mean an inclusive or and not an exclusive or. Specifically, a condition A or B is satisfied by any one of the following: A is true (or present) and B is false (or not present), A is false (or not present) and B is true (or present), and both A and B are true (or present). The terms a and/or an are employed for grammatical style and merely for convenience.

The term plurality is intended to mean two or more than two. The term any is intended to mean all applicable members of a set or at least a subset of all applicable members of the set. The phrase any integer derivable therein is intended to mean an integer between the corresponding numbers recited in the specification. The phrase any range derivable therein is intended to mean any range within such corresponding numbers. The term means, when followed by the term “for” is intended to mean hardware, firmware and/or software for achieving a result. The term step, when followed by the term “for” is intended to mean a (sub)method, (sub)process and/or (sub)routine for achieving the recited result. Unless otherwise defined, all technical and scientific terms used herein have the same meaning as commonly understood by one of ordinary skill in the art to which this present disclosure belongs. In case of conflict, the present specification, including definitions, will control.

The described embodiments and examples are illustrative only and not intended to be limiting. Although embodiments of the present disclosure can be implemented separately, embodiments of the present disclosure may be integrated into the system(s) with which they are associated. All the embodiments of the present disclosure disclosed herein can be made and used without undue experimentation in light of the disclosure. Embodiments of the present disclosure are not limited by theoretical statements (if any) recited herein. The individual steps of embodiments of the present disclosure need not be performed in the disclosed manner, or combined in the disclosed sequences, but may be performed in any and all manner and/or combined in any and all sequences. The individual components of embodiments of the present disclosure need not be combined in the disclosed configurations, but could be combined in any and all configurations.

Various substitutions, modifications, additions and/or rearrangements of the features of embodiments of the present disclosure may be made without deviating from the scope of the underlying inventive concept. All the disclosed elements and features of each disclosed embodiment can be combined with, or substituted for, the disclosed elements and features of every other disclosed embodiment except where such elements or features are mutually exclusive. The scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” or “mechanism for” or “step for”. Sub-generic embodiments of this disclosure are delineated by the appended independent claims and their equivalents. Specific embodiments of this disclosure are differentiated by the appended dependent claims and their equivalents.

### REFERENCES

[1] “A Case for Assisted Partial Timing Support Using Precision Timing Protocol Packet Synchronization for LTE-A”, IEEE Communications Magazine, July. 2014.
[2] “Backplane Timing Distribution”, U.S. patent application Ser. No. 14/285,522, May 2014.

What is claimed is:

1. A method, comprising: distributing timing including phase and frequency from a server to at least one client over a radio link.

2. The method of claim 1, wherein distributing includes transmitting a first transmission event defining a first start of frame from the server to at least one client over the radio link.

3. The method of claim 2, wherein transmitting the first transmission event is aligned with a seconds rollover of a clock.

4. The method of claim 3, wherein transmitting the first transmission event is repeated approximately once per second.

5. The method of claim 2, wherein distributing includes transmitting a second transmission event defining a second start of frame from the at least one client to the server over the radio link.

6. The method of claim 5, wherein transmitting the first transmission event is repeated approximately once per second and transmitting the second transmission event is repeated approximately once per second.

7. The method of claim 6, wherein distributing includes completing a two-way burst communication within a one second interval.

8. The method of claim 5. Wherein transmitting the second transmission event includes time shifting a client local signal that is fed back to a local phase detector located in the at least one client to be in alignment with a server master signal that is fed back to a master phase detector located in the server.

9. The method of claim 1, wherein the at least one client includes a plurality of clients and distributing includes multicasting where each of the plurality of clients is allotted its own time slot.

10. A non-transitory computer readable media comprising executable programming instructions for performing the method of claim 1.

11. An apparatus, comprising a server and at least one client coupled to the server,
wherein timing including phase and frequency is distributed from a server to a at least one client over a radio link including transmitting a first transmission event defining a first start of frame from the server to at least one client over the radio link and transmitting a second transmission event defining a second start of frame from the at least one client to the server over the radio link and
wherein transmitting the first transmission event is repeated approximately once per second and transmitting the second transmission event is repeated approximately once per second.
